(19) United States
(12) Patent Application Publication
(10) Pub. No.: US 2025/0079576 A1
(43) Pub. Date: Mar. 6, 2025

(54) PLASTIC COMPOSITION FOR ENERGY STORAGE BATTERIES AND BATTERY HAVING THE SAME

(71) Applicant: Zhejiang Jinko Energy Storage Co., Ltd., Haining City (CN)

(72) Inventor: Mengting LU, Haining City (CN)

(21) Appl. No.: 18/949,978

(22) Filed: Nov. 15, 2024

(30) Foreign Application Priority Data
Aug. 30, 2024 (CN) 202411217238.X

(51) Int. Cl. H01M 50/122; C08G 75/14; C08K 3/04; C08K 3/40; C08K 7/14; C08K 7/20

(52) U.S. Cl. CPC H01M 50/122; C08G 75/14; C08K 3/04; C08K 3/40; C08K 7/14; C08K 7/20

(57) ABSTRACT

Disclosed are a plastic composition for energy storage batteries and a battery having the same. The plastic composition for energy storage batteries includes modified polyphenylene sulfide, an auxiliary material, and a compatibilizer. The main component of the plastic composition is modified polyphenylene sulfide, which is modified by introducing functional groups, including but not limited to methyl, ethyl, trifluoromethyl, methoxy. The auxiliary material includes one or more of glass fiber, chopped carbon fiber, silicon dioxide, and glass microsphere. The compatibilizer includes one or more of epoxy resin, PE-g-ST, PP-g-ST, ABS-g-MAH, PE-g-MAH, and PP-g-MAH.

### CROSS REFERENCE TO RELATED APPLICATIONS

The present application claims the benefit of priority under Paris Convention to Chinese Patent Application No. 202411217238.X, entitled “PLASTIC COMPOSITION FOR ENERGY STORAGE BATTERIES AND BATTERY HAVING THE SAME”, filed on Aug. 30, 2024, the entire disclosure of which is incorporated herein by reference in its entirety.

### TECHNICAL FIELD

The present disclosure pertains to the technical field of photovoltaic, and in particular to a plastic composition for energy storage batteries and a battery having the same.

### BACKGROUND

A top cover of an energy storage battery is an assembly of pole posts, an upper plastic, a top cover sheet, an explosion-proof film protective sheet, an explosion-proof film, and a lower plastic. The upper plastic functions to secure the pole posts and ensure stable charging and discharging connectivity. Additionally, it also functions as insulation and weak conduction.

The main component of the plastic is polyphenylene sulfide. Carbon black is generally added to the upper plastic of the positive electrode to enhance the conductivity of the material. Although the upper plastic can meet existing applications, the upper plastic is prone to creep in long-term use due to insufficient strength, and thereby cannot play the role of securing and sealing, resulting in unstable charging and discharging processes, as well as the risk of battery leakage, further affecting the performance of the battery and causing the failure of the battery module and the energy storage system.

To address the issue that the upper plastic cannot play the role of sealing due to insufficient strength during usage and the battery performance is thereby affected, embodiments of the present disclosure provide a plastic composition for energy storage batteries and a battery having the same.

### SUMMARY

To address the issue that the upper plastic cannot play the role of sealing due to insufficient strength during usage and the battery performance is thereby affected, embodiments of the present disclosure provide a plastic composition for energy storage batteries and a battery having the same. The plastic composition for energy storage batteries includes modified polyphenylene sulfide, an auxiliary material, and a compatibilizer. The modified polyphenylene sulfide includes a repeating structure represented by formula (I):

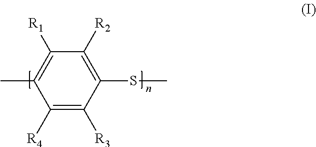

where R1, R2, R3, and R4 represent modification groups, and the modification groups include one or more of methyl, ethyl, trifluoromethyl, and methoxy.

The main component of the upper plastic is polyphenylene sulfide, which is a new type of high-performance thermoplastic resin. It has advantages such as high mechanical strength, high temperature resistance, chemical resistance, flame retardancy, good thermal stability, and excellent electrical properties. It is widely used in the fields of electronics, automotive, machinery, and chemical industries. By grafting different functional groups onto the main polyphenylene sulfide, modified polyphenylene sulfides with varying thermal stabilities can be obtained. The modified polyphenylene sulfide resin has a number average molecular weight ranging from 50,000 to 10,000, which enables the formed upper plastic to have excellent mechanical strength, deformation resistance, corrosion resistance, heat resistance, heat dissipation, and creep resistance.

Introducing an auxiliary material during the synthesis of the upper plastic can improve the strength and mechanical properties of the product while ensuring the main material functions effectively. Introducing a compatibilizer during the synthesis of the upper plastic, can effectively improve the compatibility between the components of the blend, strengthen the interfacial adhesion between the modified polyphenylene sulfide and the auxiliary material, and further improve the material's strength.

In some embodiments, the modified polyphenylene sulfide includes one of the following structures:

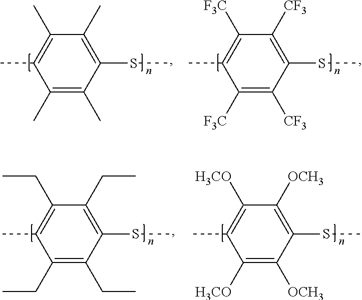

Although the tensile strength and bending strength of the aforementioned polyphenylene sulfide are relatively strong, the upper plastic obtained solely from the above the aforementioned polyphenylene sulfide exhibits poor rate of elongation, impact strength, or other mechanical properties. Therefore, a certain quantity of auxiliary materials may be added during the synthesis process of the upper plastic, to further improve the strength and mechanical properties of the material while ensuring the heat resistance, flame retardancy, and chemical stability of polyphenylene sulfide.

In some embodiments, the mass ratio of the modified polyphenylene sulfide, auxiliary material, and compatibilizer is (1 to 10):(0.1 to 3):(1 to 2).

In some embodiments, the auxiliary material includes one or more of glass fiber, chopped carbon fiber, silicon dioxide, and glass microspheres.

In some embodiments, the glass fiber has a mesh count ranging from 10,000 to 15,000 and a length ranging from 1 μm to 50 μm; and the diameter of the chopped carbon fiber ranges from 5 μm to 8 μm.

In some embodiments, the silicon dioxide has a mesh count ranging from 2000 to 2500; and the particle size of the glass microsphere ranges from 2 μm to 250 μm.

In some embodiments, the compatibilizer includes one or more of epoxy resin, PE-g-ST, PP-g-ST, ABS-g-MAH, PE-g-MAH, and PP-g-MAH.

In order to better take advantage of the main and auxiliary materials and achieve a synergistic effect, a compatibilizer is added during the synthesis process of the upper plastic. The primary function of the compatibilizer is to enhance the compatibility between incompatible polymers. The compatibilizer is distributed in the form of an interfacial agent between the two-phase interfaces of the blend. In addition, the compatibilizer can promote the dispersion of the two phases during the blending process of the main and auxiliary materials, prevent the coalescence of the dispersed phase, thereby improving the microstructure of the blend, and further affecting its properties. The compatibilizer can enhance interfacial adhesion, facilitate stress transfer between components, improve the stability of the blend system, and enhance the mechanical and overall properties of the material.

In some embodiments, the plastic composition is applied to the preparation of upper plastic of batteries, and the preparation method of the upper plastic includes:
placing the modified polyphenylene sulfide, the auxiliary material, and the compatibilizer, according to a specified ratio, into a high-speed mixer, stirring a mixture thereof uniformly, and obtaining an upper plastic precursor through melting and extrusion; curing the upper plastic precursor in a mold to obtain a finished upper plastic.

In some embodiments, the preparation method specifically includes:
after uniformly mixing the modified polyphenylene sulfide and the auxiliary material, according to a specified ratio, in the high-speed mixer, adding the uniformly mixed modified polyphenylene sulfide and auxiliary material into a hopper of a twin-screw extruder, adding the compatibilizer simultaneously through a side feed of the twin-screw extruder, and obtaining the upper plastic precursor through melting and extrusion, where a rotational speed of the high-speed mixer ranges from 300 r/min to 500 r/min, and the twin-screw extruder is divided into eight regions from the hopper to a machine head thereof, the eight regions respectively have temperatures ranging from 220° C. to 250° C., 260° C. to 270° C., 265° C. to 275° C., 267° C. to 275° C., 260° C. to 270° C., 250° C. to 260° C., 245° C. to 255° C., and 240° C. to 250° C. A mold head temperature ranges from 270° C. and 285° C., a rotational speed of a screw ranges from 300 r/min to 350 r/min, and a rotational speed of feed ranges from 10 Hz to 15 Hz. The upper plastic precursor is cured in the mold of the upper plastic. The shape is fixed while the upper plastic precursor is cured, obtaining a finished upper plastic.

Embodiments of the present disclosure also provide a battery, where the upper plastic of an end cap of the battery is prepared from any of the aforementioned plastics.

Embodiments of the present disclosure provide a plastic composition for energy storage batteries and a battery having the same. The plastic composition for energy storage batteries includes modified polyphenylene sulfide, an auxiliary material, and a compatibilizer, with a mass ratio of (1 to 10):(0.1 to 3):(1 to 2).

The main component of the plastic composition is modified polyphenylene sulfide, which is modified by introducing functional groups, including but not limited to methyl, ethyl, trifluoromethyl, methoxy, etc., aiming to enhance the material's strength and thermal stability. Introducing an auxiliary material during the synthesis of the upper plastic of the battery end cap can improve the strength and mechanical properties of the product while ensuring the main material functions effectively. According to the present disclosure, a compatibilizer is also introduced during material synthesis. The compatibilizer includes one or more of epoxy resin, PE-g-ST, PP-g-ST, ABS-g-MAH, PE-g-MAH, and PP-g-MAH, which can effectively improve the compatibility between the components of the blend, strengthen the interfacial adhesion between the modified polyphenylene sulfide and the auxiliary material, further improve the material's strength, and also address the issue that the upper plastic cannot play the role of sealing due to insufficient strength during usage and the battery performance is thereby affected. Embodiments of the present disclosure further provide a battery, where the upper plastic of the battery end cap is prepared from the plastic composition provided in the embodiments of the present disclosure.

### BRIEF DESCRIPTION OF THE DRAWINGS

In order to illustrate the technical solutions in the embodiments of the present disclosure more clearly, the drawings used in the description of the embodiments are briefly described below. It is apparent that other drawings may be obtained by those of ordinary skill in the art based on these drawings without any creative efforts.

FIG. 1 is a schematic diagram of the overall structure of a top cover of an energy storage battery.

Reference numerals in the drawings are listed as follows: 1 protective sheet, 2 upper plastic, 3 aluminum sheet, 4 sealing ring, 5 lower plastic, 6 pole post, 7 explosion-proof valve.

### DETAILED DESCRIPTION OF THE EMBODIMENTS

The embodiments will be described in detail below, and the examples thereof are illustrated in the accompanying drawings. When referring to the accompanying drawings in the following description, unless otherwise indicated, the same number in different drawings represents the same or similar elements. The implementations described in the following embodiments do not represent all implementations covered by the present disclosure. They are merely examples of the system and method that are consistent with some aspects of the present disclosure as detailed in the claims.

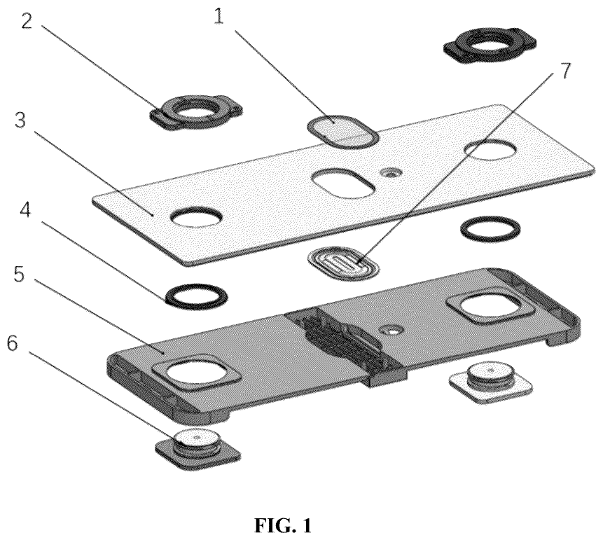

The overall structure of a top cover of an energy storage battery, as shown in FIG. 1, includes: a protective sheet 1, upper plastics 2, an aluminum sheet 3, sealing rings 4, lower plastics 5, pole posts 6, and an explosion-proof valve 7. The upper plastics 2 function to secure the pole posts 6 and ensure stable charging and discharging connectivity. Additionally, they also function as insulation and weak conduction. Although the upper plastics 2 can meet existing applications, the upper plastics 2 are prone to creep in long-term use, and thereby cannot play the role of securing and sealing, resulting in unstable charging and discharging processes, as well as the risk of battery leakage, further affecting the performance of the battery and causing the failure of the battery module and the energy storage system.

To address the issue that the upper plastic cannot play the role of sealing due to insufficient strength during usage and the battery performance is thereby affected, embodiments of the present disclosure provide a plastic composition for energy storage batteries and a battery having the same. The plastic composition for energy storage batteries includes modified polyphenylene sulfide, an auxiliary material, and a compatibilizer. The modified polyphenylene sulfide includes a repeating structure represented by formula (I):

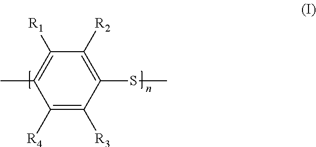

where R1, R2, R3, and R4 represent modification groups, and the modification groups include one or more of methyl, ethyl, trifluoromethyl, and methoxy.

The main component of the upper plastic is polyphenylene sulfide, which is a new type of high-performance thermoplastic resin. It has advantages such as high mechanical strength, high temperature resistance, chemical resistance, flame retardancy, good thermal stability, and excellent electrical properties. It is widely used in the fields of electronics, automotive, machinery, and chemical industries. By grafting different functional groups onto the main polyphenylene sulfide, modified polyphenylene sulfides with varying thermal stabilities can be obtained. The modified polyphenylene sulfide resin has a number average molecular weight ranging from 50,000 to 10,000, which enables the formed upper plastic to have excellent mechanical strength, deformation resistance, corrosion resistance, heat resistance, heat dissipation, and creep resistance.

The main component of the upper plastic is polyphenylene sulfide. By grafting different functional groups onto the main polyphenylene sulfide, modified polyphenylene sulfides with varying thermal stabilities can be obtained. The functional groups include, but are not limited to, methyl, ethyl, trifluoromethyl, and methoxy. The specific synthesis method is as follows. Using modified dichlorobenzene and sodium sulfide as raw materials, modified polyphenylene sulfide is prepared by solution polymerization in polar organic solvents such as hexamethylenetetramine phosphate (HPT) or N-methyl pyrrolidone (NMP) at a temperature ranging from 175° C. to 350° C. under normal pressure. The by-product of the reaction is sodium chloride.

The repeating structure of modified dichlorobenzene is as follows:

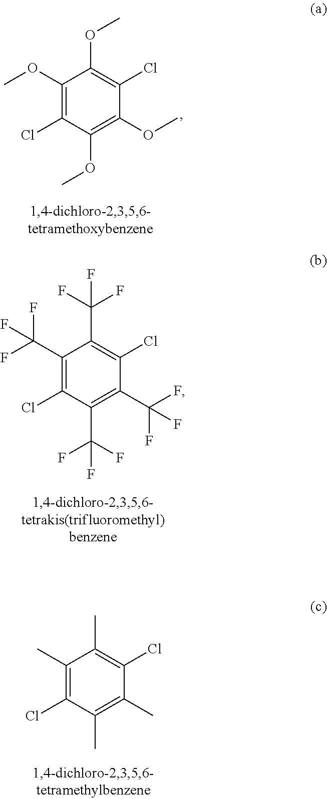

where the chemical formula for (a) is C₁₀H₁₂Cl₂O₄, the chemical formula for (b) is C₁₀Cl₁₂F₁₂, and the chemical formula for (c) is C₁₀H₁₂Cl₂.

The modified polyphenylene sulfide resin has a number average molecular weight ranging from 50,000 to 10,000, which enables the formed upper plastic to have excellent mechanical strength, deformation resistance, corrosion resistance, heat resistance, heat dissipation, and creep resistance.

Introducing an auxiliary material during the synthesis of the upper plastic can improve the strength and mechanical properties of the product while ensuring the main material functions effectively. Introducing a compatibilizer during the synthesis of the upper plastic, can effectively improve the compatibility between the components of the blend, strengthen the interfacial adhesion between the modified polyphenylene sulfide and the auxiliary material, and further improve the material's strength.

In some embodiments, the modified polyphenylene sulfide includes one of the following structures:

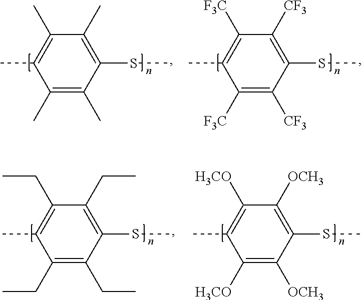

Although the tensile strength and bending strength of the aforementioned polyphenylene sulfide are relatively strong, the upper plastic obtained solely from the above the aforementioned polyphenylene sulfide exhibits poor rate of elongation, impact strength, or other mechanical properties. Therefore, a certain quantity of auxiliary materials may be added during the synthesis process of the upper plastic, to further improve the strength and mechanical properties of the material while ensuring the heat resistance, flame retardancy, and chemical stability of polyphenylene sulfide.

In some embodiments, the mass ratio of the modified polyphenylene sulfide, auxiliary material, and compatibilizer is (1 to 10):(0.1 to 3):(1 to 2).

In some embodiments, the auxiliary material includes one or more of glass fiber, chopped carbon fiber, silicon dioxide, and glass microspheres.

In some embodiments, the glass fiber has a mesh count ranging from 10,000 to 15,000 and a length ranging from 1 μm to 50 μm; and the diameter of the chopped carbon fiber ranges from 5 μm to 8 μm.

In some embodiments, the silicon dioxide has a mesh count ranging from 2000 to 2500; and the particle size of the glass microsphere ranges from 2 μm to 250 μm.

In some embodiments, the compatibilizer includes one or more of epoxy resin, PE-g-ST, PP-g-ST, ABS-g-MAH, PE-g-MAH, and PP-g-MAH.

In order to better take advantage of the main and auxiliary materials and achieve a synergistic effect, a compatibilizer is added during the synthesis process of the upper plastic. The primary function of the compatibilizer is to enhance the compatibility between incompatible polymers. The compatibilizer is distributed in the form of an interfacial agent between the two-phase interfaces of the blend. In addition, the compatibilizer can promote the dispersion of the two phases during the blending process of the main and auxiliary materials, prevent the coalescence of the dispersed phase, thereby improving the microstructure of the blend, and further affecting its properties. The compatibilizer can enhance interfacial adhesion, facilitate stress transfer between components, improve the stability of the blend system, and enhance the mechanical and overall properties of the material.

In some embodiments, the plastic composition is applied to the preparation of upper plastic of batteries, and the preparation method of the upper plastic is as follows: the modified polyphenylene sulfide, the auxiliary material, and the compatibilizer are placed, according to a specified ratio, into a high-speed mixer, a mixture thereof is stirred uniformly, and an upper plastic precursor through melting and extrusion is obtained; the upper plastic precursor is cured in a mold to obtain a finished upper plastic.

In some embodiments, the preparation method is as follows: after the modified polyphenylene sulfide and the auxiliary material are uniformly mixed, according to a specified ratio, in the high-speed mixer, the uniformly mixed modified polyphenylene sulfide and auxiliary material are added into a hopper of a twin-screw extruder, the compatibilizer is simultaneously added through a side feed of the twin-screw extruder, and the upper plastic precursor is obtained through melting and extrusion. A rotational speed of the high-speed mixer ranges from 300 r/min to 500 r/min, and the twin-screw extruder is divided into eight regions from the hopper to a machine head thereof, the eight regions respectively have temperatures ranging from 220° C. to 250° C., 260° C. to 270° C., 265° C. to 275° C., 267° C. to 275° C., 260° C. to 270° C., 250° C. to 260° C., 245° C. to 255° C., and 240° C. to 250° C. A mold head temperature ranges from 270° C. and 285° C., a rotational speed of a screw ranges from 300 r/min to 350 r/min, and a rotational speed of feed ranges from 10 Hz to 15 Hz. The upper plastic precursor is cured in the mold of the upper plastic. The shape is fixed while the upper plastic precursor is cured, obtaining a finished upper plastic.

Embodiments of the present disclosure also provide a battery, where the upper plastic of an end cap of the battery is prepared from any of the aforementioned plastics, and the end cap refers to the top cover of the battery.

### First Embodiment

After uniformly mixing the modified polyphenylene sulfide and glass fiber as an auxiliary material in a high-speed mixer, the uniformly mixed modified polyphenylene sulfide and the auxiliary material are added into a hopper of a twin-screw extruder, epoxy resin as a compatibilizer is simultaneously added through a side feed of the twin-screw extruder, and an upper plastic precursor is obtained through melting and extrusion.

The modified polyphenylene sulfide is modified with methyl groups on both the ortho and meta positions. The mass ratio of the modified polyphenylene sulfide, auxiliary material, and compatibilizer in this embodiment is 1:0.1:1. The glass fiber has a mesh count of 10,000 and a length of 1 μm.

A rotational speed of the high-speed mixer is 300 r/min. The twin-screw extruder is divided into eight regions from the hopper to a machine head thereof, and the eight regions respectively have temperatures of 220° C., 260° C., 265° C., 267° C., 260° C., 250° C., 245° C., and 240° C. A mold head temperature is 270° C., a rotational speed of a screw is 300 r/min, and a rotational speed of feed is 10 Hz.

The upper plastic precursor is cured in the mold of the upper plastic. The shape is fixed while the upper plastic precursor is cured, obtaining a first upper plastic.

### Second Embodiment

After uniformly mixing the modified polyphenylene sulfide and chopped carbon fiber as an auxiliary material in a high-speed mixer, the uniformly mixed modified polyphenylene sulfide and the auxiliary material are added into a hopper of a twin-screw extruder, PE-g-ST as a compatibilizer is simultaneously added through a side feed of the twin-screw extruder, and an upper plastic precursor is obtained through melting and extrusion.

The modified polyphenylene sulfide is modified with ethyl groups on both the ortho and meta positions. The mass ratio of the modified polyphenylene sulfide, auxiliary material, and compatibilizer in this embodiment is 1:3:2. The diameter of the chopped carbon fiber is 5 μm.

A rotational speed of the high-speed mixer is 500 r/min. The twin-screw extruder is divided into eight regions from the hopper to a machine head thereof, and the eight regions respectively have temperatures of 250° C., 270° C., 275° C., 275° C., 270° C., 260° C., 255° C., and 250° C. A mold head temperature is 285° C., a rotational speed of a screw is 350 r/min, and a rotational speed of feed is 15 Hz.

The upper plastic precursor is cured in the mold of the upper plastic. The shape is fixed while the upper plastic precursor is cured, obtaining a second upper plastic.

### Third Embodiment

After uniformly mixing the modified polyphenylene sulfide and silicon dioxide as an auxiliary material in a high-speed mixer, the uniformly mixed modified polyphenylene sulfide and the auxiliary material are added into a hopper of a twin-screw extruder, PP-g-ST as a compatibilizer is simultaneously added through a side feed of the twin-screw extruder, and an upper plastic precursor is obtained through melting and extrusion.

The modified polyphenylene sulfide is modified with trifluoromethyl groups on both the ortho and meta positions. The mass ratio of the modified polyphenylene sulfide, auxiliary material, and compatibilizer in this embodiment is 10:0.1:1. The silicon dioxide has a mesh count ranging from 2000 to 2500.

A rotational speed of the high-speed mixer is 400 r/min. The twin-screw extruder is divided into eight regions from the hopper to a machine head thereof, and the eight regions respectively have temperatures of 240° C., 265° C., 270° C., 271° C., 267° C., 255° C., 250° C., and 245° C. A mold head temperature is 280° C., a rotational speed of a screw is 330 r/min, and a rotational speed of feed is 13 Hz.

The upper plastic precursor is cured in the mold of the upper plastic. The shape is fixed while the upper plastic precursor is cured, obtaining a third upper plastic.

### Fourth Embodiment

After uniformly mixing the modified polyphenylene sulfide and glass microsphere as an auxiliary material in a high-speed mixer, the uniformly mixed modified polyphenylene sulfide and the auxiliary material are added into a hopper of a twin-screw extruder, ABS-g-MAH as a compatibilizer is simultaneously added through a side feed of the twin-screw extruder, and an upper plastic precursor is obtained through melting and extrusion.

The modified polyphenylene sulfide is modified with methoxy groups on both the ortho and meta positions. The mass ratio of the modified polyphenylene sulfide, auxiliary material, and compatibilizer in this embodiment is 10:3:2. The particle size of the glass microsphere is 2 μm.

A rotational speed of the high-speed mixer is 400 r/min. The twin-screw extruder is divided into eight regions from the hopper to a machine head thereof, and the eight regions respectively have temperatures of 240° C., 265° C., 270° C., 271° C., 267° C., 255° C., 250° C., and 245° C. A mold head temperature is 280° C., a rotational speed of a screw is 330 r/min, and a rotational speed of feed is 13 Hz.

The upper plastic precursor is cured in the mold of the upper plastic. The shape is fixed while the upper plastic precursor is cured, obtaining a fourth upper plastic.

### Fifth Embodiment

After uniformly mixing the modified polyphenylene sulfide and glass fiber and chopped carbon fiber as an auxiliary material in a high-speed mixer, the uniformly mixed modified polyphenylene sulfide and the auxiliary material are added into a hopper of a twin-screw extruder, PE-g-MAH as a compatibilizer is simultaneously added through a side feed of the twin-screw extruder, and an upper plastic precursor is obtained through melting and extrusion.

The modified polyphenylene sulfide is modified with methyl groups on both the ortho and meta positions. The mass ratio of the modified polyphenylene sulfide, auxiliary material, and compatibilizer in this embodiment is 5:1:1. The glass fiber has a mesh count of 15000 and a length of 50 μm. The diameter of the chopped carbon fiber is 8 μm.

A rotational speed of the high-speed mixer is 400 r/min. The twin-screw extruder is divided into eight regions from the hopper to a machine head thereof, and the eight regions respectively have temperatures of 240° C., 265° C., 270° C., 271° C., 267° C., 255° C., 250° C., and 245° C. A mold head temperature is 280° C., a rotational speed of a screw is 330 r/min, and a rotational speed of feed is 13 Hz.

The upper plastic precursor is cured in the mold of the upper plastic. The shape is fixed while the upper plastic precursor is cured, obtaining a fifth upper plastic.

### Sixth Embodiment

After uniformly mixing the modified polyphenylene sulfide and, glass fiber, chopped carbon fiber, silicon dioxide, and glass microsphere as an auxiliary material in a high-speed mixer, the uniformly mixed modified polyphenylene sulfide and the auxiliary material are added into a hopper of a twin-screw extruder, PP-g-MAH as a compatibilizer is simultaneously added through a side feed of the twin-screw extruder, and an upper plastic precursor is obtained through melting and extrusion.

The modified polyphenylene sulfide is modified with methyl, ethyl, trifluoromethyl, and methoxy groups at both the ortho and meta positions. The mass ratio of the modified polyphenylene sulfide, auxiliary material, and compatibilizer in this embodiment is 6:2:1. The glass fiber has a mesh count of 13000 and a length of 30 μm. The diameter of the chopped carbon fiber is 7 μm, and the silicon dioxide has a mesh count of 2500. The particle size of the glass microsphere is 250 μm.

A rotational speed of the high-speed mixer is 400 r/min. The twin-screw extruder is divided into eight regions from the hopper to a machine head thereof, and the eight regions respectively have temperatures of 240° C., 265° C., 270° C., 271° C., 267° C., 255° C., 250° C., and 245° C. A mold head temperature is 280° C., a rotational speed of a screw is 330 r/min, and a rotational speed of feed is 13 Hz.

The upper plastic precursor is cured in the mold of the upper plastic. The shape is fixed while the upper plastic precursor is cured, obtaining a sixth upper plastic.

### Seventh Embodiment

After uniformly mixing the modified polyphenylene sulfide and glass fiber, chopped carbon fiber, silicon dioxide, and glass microsphere as an auxiliary material in a high-speed mixer, the uniformly mixed modified polyphenylene sulfide and the auxiliary material are added into a hopper of a twin-screw extruder, epoxy resin, PE-g-ST, PP-g-ST, and ABS-g-MAH as a compatibilizer are simultaneously added through a side feed of the twin-screw extruder, and an upper plastic precursor is obtained through melting and extrusion.

The modified polyphenylene sulfide is modified with ethyl groups on both the ortho and meta positions. The mass ratio of the modified polyphenylene sulfide, auxiliary material, and compatibilizer in this embodiment is 5:2:1.5. The glass fiber has a mesh count of 13000 and a length of 40 μm. The diameter of the chopped carbon fiber is 6 μm, and the silicon dioxide has a mesh count of 2200. The particle size of the glass microsphere is 100 μm.

A rotational speed of the high-speed mixer is 400 r/min. The twin-screw extruder is divided into eight regions from the hopper to a machine head thereof, and the eight regions respectively have temperatures of 240° C., 265° C., 270° C., 271° C., 267° C., 255° C., 250° C., and 245° C. A mold head temperature is 280° C., a rotational speed of a screw is 330 r/min, and a rotational speed of feed is 13 Hz.

The upper plastic precursor is cured in the mold of the upper plastic. The shape is fixed while the upper plastic precursor is cured, obtaining a seventh upper plastic.

### First Comparative Example

After uniformly mixing the modified polyphenylene sulfide and glass fiber as an auxiliary material in a high-speed mixer, the uniformly mixed modified polyphenylene sulfide and the auxiliary material are added into a hopper of a twin-screw extruder, and an upper plastic precursor is obtained through melting and extrusion.

The modified polyphenylene sulfide is modified with methyl groups on both the ortho and meta positions. The mass ratio of the modified polyphenylene sulfide and auxiliary material in this example is 1:3. The glass fiber has a mesh count of 10,000 and a length of 1 μm.

A rotational speed of the high-speed mixer is 400 r/min. The twin-screw extruder is divided into eight regions from the hopper to a machine head thereof, and the eight regions respectively have temperatures of 240° C., 265° C., 270° C., 271° C., 267° C., 255° C., 250° C., and 245° C. A mold head temperature is 280° C., a rotational speed of a screw is 330 r/min, and a rotational speed of feed is 13 Hz.

The upper plastic precursor is cured in the mold of the upper plastic. The shape is fixed while the upper plastic precursor is cured, obtaining a first comparative upper plastic.

### Second Comparative Example

After uniformly mixing the modified polyphenylene sulfide and epoxy resin and PE-g-ST as a compatibilizer in a high-speed mixer, the uniformly mixed modified polyphenylene sulfide and the compatibilizer are added into a hopper of a twin-screw extruder, and an upper plastic precursor is obtained through melting and extrusion.

The modified polyphenylene sulfide is modified with methyl groups on both the ortho and meta positions. The mass ratio of the modified polyphenylene sulfide and compatibilizer in this example is 1:2.

A rotational speed of the high-speed mixer is 400 r/min. The twin-screw extruder is divided into eight regions from the hopper to a machine head thereof, and the eight regions respectively have temperatures of 240° C., 265° C., 270° C., 271° C., 267° C., 255° C., 250° C., and 245° C. A mold head temperature is 280° C., a rotational speed of a screw is 330 r/min, and a rotational speed of feed is 13 Hz.

The upper plastic precursor is cured in the mold of the upper plastic. The shape is fixed while the upper plastic precursor is cured, obtaining a second comparative upper plastic.

Measurements were conducted on the upper plastics produced in Embodiments 1 to 7 and Comparative Examples 1 to 2, and the results are presented in Table 1. The testing methods involve: testing tensile strength and tensile modulus in accordance with ISO527 standard; testing notch impact strength in accordance with ISO179 standard; testing horizontal shrinkage rate and longitudinal shrinkage rate in accordance with ISO294 standard; testing linear expansion coefficient in accordance with ASTM D696 standard; and testing thermal deformation temperature in accordance with ISO294 standard.

TABLE 1
Measurement results

| | | | | Notch | | | Linear | Thermal |
|---|---|---|---|---|---|---|---|---|
| | | Tensile | Tensile | Impact | Horizontal | Longitudinal | expansion | deformation |
| | Density | Strength | Modulus | Strength | Shrinkage | shrinkage | coefficient | temperature |
| Sample | (g/cm³) | (Mpa) | (Mpa) | (KJ/m²) | rate | rate | (mm/mm*° C.) | (° C.) |
| First | 1.4 | 142 | 12322 | 9 | 0.1% | 0.15 | 20*10⁻⁶ | 150 |
| upper plastic | | | | | | | | |
| Second | 1.5 | 145 | 12789 | 9 | 0.2 | 0.16 | 32*10⁻⁶ | 176 |
| upper plastic | | | | | | | | |
| Third | 1.7 | 153 | 16824 | 10 | 0.2 | 0.25 | 28*10⁻⁶ | 165 |
| upper plastic | | | | | | | | |
| Fourth | 1.7 | 157 | 17893 | 14 | 0.3 | 0.30 | 27*10⁻⁶ | 213 |
| upper plastic | | | | | | | | |
| Fifth | 1.8 | 160 | 16593 | 12 | 0.1 | 0.25 | 23*10⁻⁶ | 252 |
| upper plastic | | | | | | | | |
| Sixth | 1.7 | 163 | 17983 | 15 | 0.3 | 0.27 | 24*10⁻⁶ | 212 |
| upper plastic | | | | | | | | |
| Seventh | 1.6 | 165 | 17824 | 13 | 0.2 | 0.25 | 35*10⁻⁶ | 251 |
| upper plastic | | | | | | | | |
| First | 1.3 | 130 | 11375 | 7 | 0.4 | 0.34 | 46*10⁻⁶ | 121 |
| comparative | | | | | | | | |
| upper plastic | | | | | | | | |
| Second | 1.2 | 133 | 11749 | 8 | 0.3 | 0.38 | 43*10⁻⁶ | 132 |
| comparative | | | | | | | | |
| upper plastic | | | | | | | | |

As evidenced from Table 1, the upper plastic provided in the embodiments of the present disclosure exhibits better strength.

Embodiments of the present disclosure provide a plastic composition for energy storage batteries and a battery having the same. The plastic composition for energy storage batteries includes modified polyphenylene sulfide, an auxiliary material, and a compatibilizer, with a mass ratio of (1 to 10):(0.1 to 3):(1 to 2).

The main component of the plastic composition is modified polyphenylene sulfide, which is modified by introducing functional groups, including but not limited to methyl, ethyl, trifluoromethyl, methoxy, etc., aiming to enhance the material's strength and thermal stability. Introducing an auxiliary material during the synthesis of the upper plastic of the battery end cap can improve the strength and mechanical properties of the product while ensuring the main material functions effectively. According to the present disclosure, a compatibilizer is also introduced during material synthesis. The compatibilizer includes one or more of epoxy resin, PE-g-ST, PP-g-ST, ABS-g-MAH, PE-g-MAH, and PP-g-MAH, which can effectively improve the compatibility between the components of the blend, strengthen the interfacial adhesion between the modified polyphenylene sulfide and the auxiliary material, further improve the material's strength, and also address the issue that the upper plastic cannot play the role of sealing due to insufficient strength during usage and the battery performance is thereby affected. Embodiments of the present disclosure further provide a battery, where the upper plastic of the battery end cap is prepared from the plastic composition provided in the embodiments of the present disclosure.

Similar parts among the embodiments provided in the present disclosure can be referred to each other. The specific implementations provided above are merely a few examples under the overall concept of the present disclosure and do not constitute a limitation on the scope of protection of the present disclosure. For those skilled in the art, any other implementations obtained on the basis of the solution of the present disclosure without creative efforts fall within the scope of protection of the present disclosure.

What is claimed is:

1. A plastic composition for energy storage batteries, comprising modified polyphenylene sulfide, an auxiliary material, and a compatibilizer, wherein the modified polyphenylene sulfide comprises a repeating structure represented by formula (I): 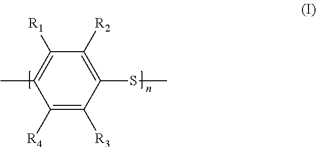
wherein R1, R2, R3, and R4 represent modification groups, and the modification groups comprise one or more of methyl, ethyl, trifluoromethyl, and methoxy.

2. The plastic composition according to claim 1, wherein the modified polyphenylene sulfide comprises one of following structures:

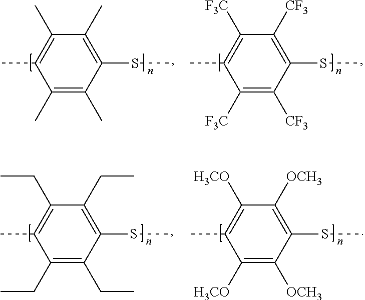

3. The plastic composition according to claim 1, wherein a mass ratio of the modified polyphenylene sulfide, auxiliary material, and compatibilizer is (1 to 10):(0.1 to 3):(1 to 2).

4. The plastic composition according to claim 1, wherein the auxiliary material comprises one or more of glass fiber, chopped carbon fiber, silicon dioxide, and glass microsphere.

5. The plastic composition according to claim 4, wherein the glass fiber has a mesh count ranging from 10,000 to 15,000 and a length ranging from 1 μm to 50 μm; and the diameter of the chopped carbon fiber ranges from 5 μm to 8 μm.

6. The plastic composition according to claim 4, wherein the silicon dioxide has a mesh count ranging from 2000 to 2500; and the particle size of the glass microsphere ranges from 2 μm to 250 μm.

7. The plastic composition according to claim 1, wherein the compatibilizer comprises one or more of epoxy resin, PE-g-ST, PP-g-ST, ABS-g-MAH, PE-g-MAH, and PP-g-MAH.

8. The plastic composition according to claim 1, wherein the modified polyphenylene sulfide is modified with methyl groups on both ortho and meta positions, the auxiliary material is glass fiber, the compatibilizer is epoxy resin, a mass ratio of the modified polyphenylene sulfide, auxiliary material, and compatibilizer is 1:0.1:1, and the glass fiber has a mesh count of 10,000 and a length of 1 μm.

9. The plastic composition according to claim 1, wherein the modified polyphenylene sulfide is modified with ethyl groups on both ortho and meta positions, the auxiliary material is chopped carbon fiber, the compatibilizer is PE-g-ST, a mass ratio of the modified polyphenylene sulfide, auxiliary material, and compatibilizer is 1:3:2, and a diameter of the chopped carbon fiber is 5 μm.

10. The plastic composition according to claim 1, wherein the modified polyphenylene sulfide is modified with trifluoromethyl groups on both ortho and meta positions, the auxiliary material is silicon dioxide, the compatibilizer is PP-g-ST, a mass ratio of the modified polyphenylene sulfide, auxiliary material, and compatibilizer is 10:0.1:1, and the silicon dioxide has a mesh count ranging from 2000 to 2500.

11. The plastic composition according to claim 1, wherein the modified polyphenylene sulfide is modified with methoxy groups on both ortho and meta positions, the auxiliary material is glass microsphere, the compatibilizer is ABS-g-MAH, a mass ratio of the modified polyphenylene sulfide, auxiliary material, and compatibilizer is 10:3:2, and a particle size of the glass microsphere is 2 μm.

12. The plastic composition according to claim 1, wherein the modified polyphenylene sulfide is modified with methyl, ethyl, trifluoromethyl, and methoxy groups at both ortho and meta positions, the auxiliary material is a combination of glass fiber, chopped carbon fiber, silicon dioxide, and glass microsphere, the compatibilizer is PP-g-MAH, a mass ratio of the modified polyphenylene sulfide, auxiliary material, and compatibilizer is 6:2:1, the glass fiber has a mesh count of 13000 and a length of 30 μm, a diameter of the chopped carbon fiber is 7 μm, the silicon dioxide has a mesh count of 2500, and a particle size of the glass microsphere is 250 μm.

13. The plastic composition according to claim 1, wherein the modified polyphenylene sulfide is modified with ethyl groups on both ortho and meta positions, the auxiliary material is a combination of glass fiber, chopped carbon fiber, silicon dioxide, and glass microsphere, the compatibilizer is a combination of epoxy resin, PE-g-ST, PP-g-ST, and ABS-g-MAH, a mass ratio of the modified polyphenylene sulfide, auxiliary material, and compatibilizer is 5:2:1.5, the glass fiber has a mesh count of 13000 and a length of 40 μm, a diameter of the chopped carbon fiber is 6 μm, the silicon dioxide has a mesh count of 2200, and a particle size of the glass microsphere is 100 μm.

14. A battery, wherein an upper plastic of an end cap of the battery is prepared from the plastic composition according to claim 1.

15. The battery according to claim 14, wherein the modified polyphenylene sulfide in the plastic composition comprises one of following structures:

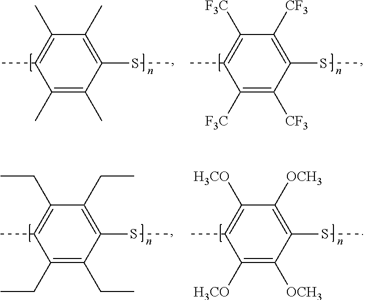

16. The battery according to claim 14, wherein a mass ratio of the modified polyphenylene sulfide, auxiliary material, and compatibilizer in the plastic composition is (1 to 10):(0.1 to 3):(1 to 2).

17. The battery according to claim 14, wherein the auxiliary material in the plastic composition comprises one or more of glass fiber, chopped carbon fiber, silicon dioxide, and glass microsphere.

18. The battery according to claim 17, wherein the glass fiber has a mesh count ranging from 10,000 to 15,000 and a length ranging from 1 μm to 50 μm; and the diameter of the chopped carbon fiber ranges from 5 μm to 8 μm.

19. The battery according to claim 17, wherein the silicon dioxide has a mesh count ranging from 2000 to 2500; and the particle size of the glass microsphere ranges from 2 μm to 250 μm.

20. The battery according to claim 14, wherein the compatibilizer in the plastic composition comprises one or more of epoxy resin, PE-g-ST, PP-g-ST, ABS-g-MAH, PE-g-MAH, and PP-g-MAH.
